(19) United States
(12) Patent Application Publication
(10) Pub. No.: US 2005/0173195 A1
(43) Pub. Date: Aug. 11, 2005

(54) Lubrication system of linear guideway

(76) Inventors: Lin Anita, Taichung (TW); Chen En-Chieh, Taichung (TW)

Correspondence Address: CHARLES E. BAXLEY, ESQ., 90 JOHN STREET, THIRD FLOOR, NEW YORK, NY, 10038, US

(21) Appl. No.: 10/774,126

(22) Filed: Feb. 6, 2004

(51) Int. Cl. F16N 1/00

(52) U.S. Cl. 184/5

(57) ABSTRACT

The present invention relates to the lubrication system of linear guideway. The lubrication system was the three-dimensional route that made the oil flow to a middle portion between the upper and lower rolling ball return ways, and therefore the oil can be averagely distributed to the upper and lower rolling ball return ways. Thereby it can increase the effect of lubricating the ball, and lower the frequency of oil resupply.

### BACKGROUND OF THE INVENTION

1. Field of the Invention

The present invention relates to a lubrication system of linear guideway, and more particularly to a lubrication system of linear guideway with three-dimensional (3D) oil route for enabling oil to flow in a 3D manner into respective rolling ball return ways to lubricate rolling balls, and the problem of oil leakage can be prevented.

2. Description of the Prior Arts

Most of machines are equipped with linear guiding structure, linear guideway is one of the linear guiding structures, and the rolling balls of the linear guideway should be well lubricated, then it can run smoothly and it service life can be maintained.

Conventionally, oil-flowing route for linear guideway, as shown in FIG. 10, has an oiling hole 61 pre-defined on the end cap 60, on contacting surface of the end cap 60 is pre-defined with oil route 62 so as to form an oil access by incorporating with the end surface of the sliding block. Along the access, the oil is able to flow on the contacting surface of the end cap 60, and then flow into the upper rolling ball return way 63 and the lower rolling ball return way 64. Furthermore, the contacting surface of the end cap is normally made into a capping plate in order to save production cost. On the capping plate is defined with oil route for introducing the oil into the rolling ball return way of the end cap. According to the two above-mentioned lubricating methods, it is uneasy to evenly allot the oil to respective rolling ball return ways since the oil flow in a same surface. Such that the rolling balls in the respective rolling ball return ways are unequally lubricated, which leads to different service lives of the rolling balls, thereby the whole service life of the linear way will be shortened. Moreover, the oil route exposed on the contacting surfaces of the end cap and of the sliding block, if there is machining error or the contacting surfaces are uneven, the oil will flow out of the contacting surfaces during oil replenishment.

The present invention has arisen to mitigate and/or obviate the afore-described disadvantages of the conventional lubrication system of linear guideway.

### SUMMARY OF THE INVENTION

The primary object of the present invention is to provide a lubrication system of linear guideway capable of averagely allotting the oil to the respective rolling ball return ways of linear guideway.

The secondary object of the present invention is to provide a lubrication system of linear guideway capable of improving tightness of the oil route.

The present invention provide a new solution to solve the uneven distribution of oil of the conventional lubrication system of linear guideway, such that the lubrication system in accordance with the present invention is possessed with an ability of allotting the oil averagely.

The present invention re-design an oil route by taking into consideration of the end cap and the capping plate of the linear guideway. By taking advantage of the spatial relationship, the conventional two-dimensional (2D) oil route structure has been revised to the three-dimensional (3D) oil route structure. The present invention forms 3D spatial oil route based on the cooperation of the end cap and the capping plate so as to enable oil to flow in a 3D manner to a middle portion between upper and lower rolling ball return ways, and then the oil is distributed averagely to respective rolling ball return ways to lubricate rolling balls. Furthermore, since the oil route structure of the present invention is formed in 3D manner, and lubricating part defined on contacting surfaces of the end cap and the capping plate and not on the contacting surfaces of the end cap and of the sliding block, therefore the problem of oil leakage from the contacting surface of the end cap and of the sliding block can be prevented substantially.

On the other hand, the capping plate of the present invention is additionally provided with a special stopping structure that is used to improve tightness. The stopping structure is disposed in the oiling hole on the contacting surfaces of the end cap and of the sliding block, so as to prevent the oil leakage from the contacting surfaces of the end cap and of the sliding block, such that tightness is improved. In addition, the stopping structure is a detachable structure that allows the oil to be injection in three different directions, so as to improve its applicability.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is an exploded view of a lubrication system of linear guideway in accordance with the present invention;

FIG. 2 is a perspective view of an end cap in FIG. 1;

FIG. 3 is a front view of the end cap in FIG. 1;

FIG. 4 is a rear view of the end cap in FIG. 1;

FIG. 5 is an assembly view of the end cap and the capping plate in accordance with the present invention;

FIG. 6 is a cross sectional view of the assembly of the end cap and the capping plate in FIG. 5;

FIG. 7 is a perspective view of a lubrication system with oiling holes formed at different sides thereof in accordance with the present invention;

FIG. 8 is a partial cross sectional view of FIG. 7;

FIG. 9 is an illustrative view of the stopping piece of the capping plate of the lubrication system in accordance with the present invention;

FIG. 10 is a cross sectional view of an end cap of conventional lubrication system of linear guideway.

### DETAILED DESCRIPTION OF THE PREFERRED EMBODIMENT

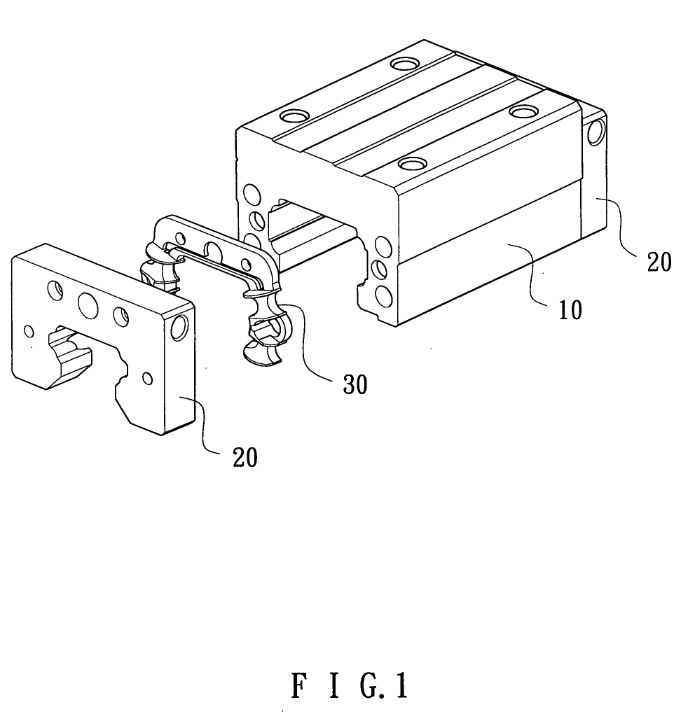

FIG. 1 is an exploded view of a lubrication system of linear guideway in accordance with the present invention. Wherein an end cap 20 and a capping plate 30 are provided at both ends of a sliding block 10. The assembly of the end cap 20 and the capping plate 30 forms rolling ball return way provided for circulation of the rolling balls.

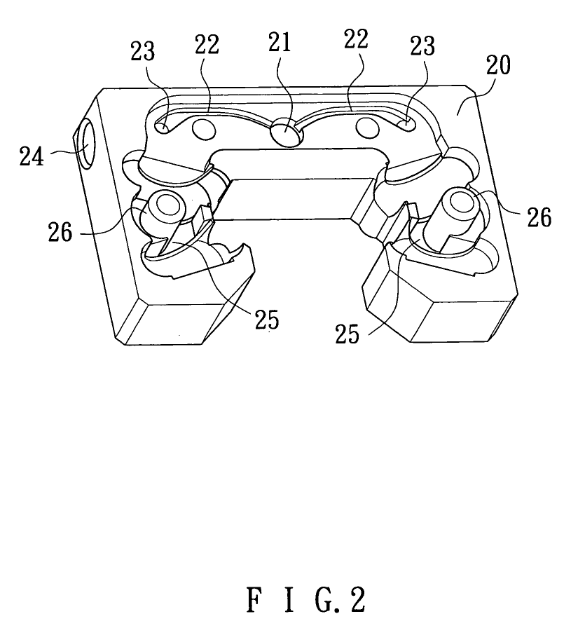

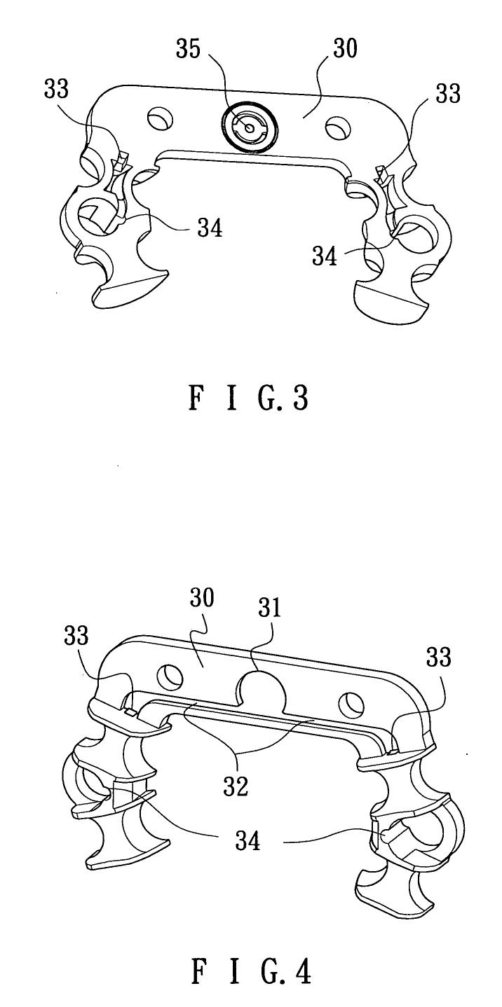

FIG. 2 is a perspective view of the end cap in FIG. 1. FIG. 3 is a front view of the end cap in FIG. 1. FIG. 4 is a rear view of the end cap in FIG. 1. Wherein the end cap 20 has two oiling holes 21 and 24 defined on the end surface and the side surface respectively. When the oil flows into oil-flowing hole 31 of the capping plate 30 from the oiling holes 21, since stopping piece 35 stops the flow of the oil into the end surface of the sliding block, the oil is introduced to both sides of the sliding block by guide route 32, and then flows into oil-flowing hole 33, and through the oil-flowing hole 33 the oil is introduced to the front surface (contacting the sliding block) of the capping plate 30 from the rear surface (contacting the end cap 20). After that, through the hole 34 at a center position between upper and lower rolling ball return ways (about the position of threaded hole 26) the oil flow back to the rear surface of the capping plate 30 that contacts the curved surface 25 of the end cap 20, so as to supply the oil to the upper and the lower rolling ball return ways for lubricating the rolling balls properly. Furthermore, if pouring into the oiling hole 24, the oil will flow into the oil route 22 via the oil-flowing hole 23 and then to be introduced into the oiling hole 21, and through the same above-mentioned route the oil flows into the upper and the lower rolling ball return ways, so to lubricate the rolling balls smoothly.

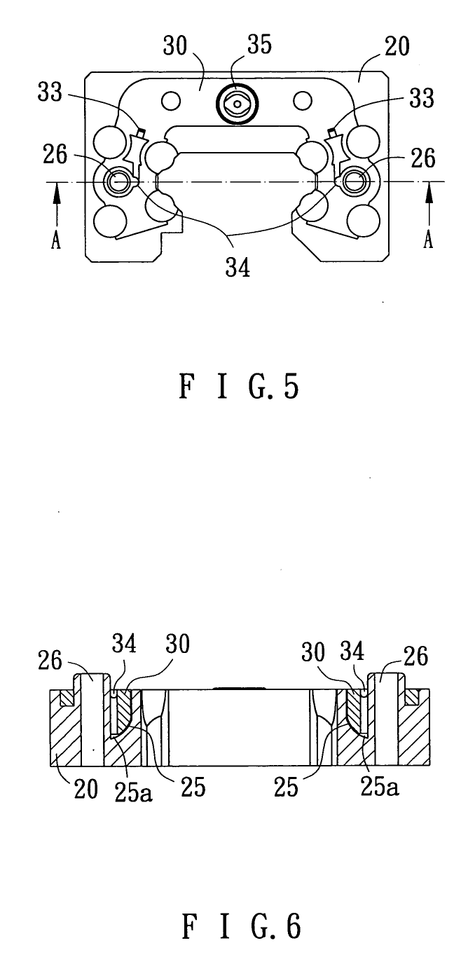

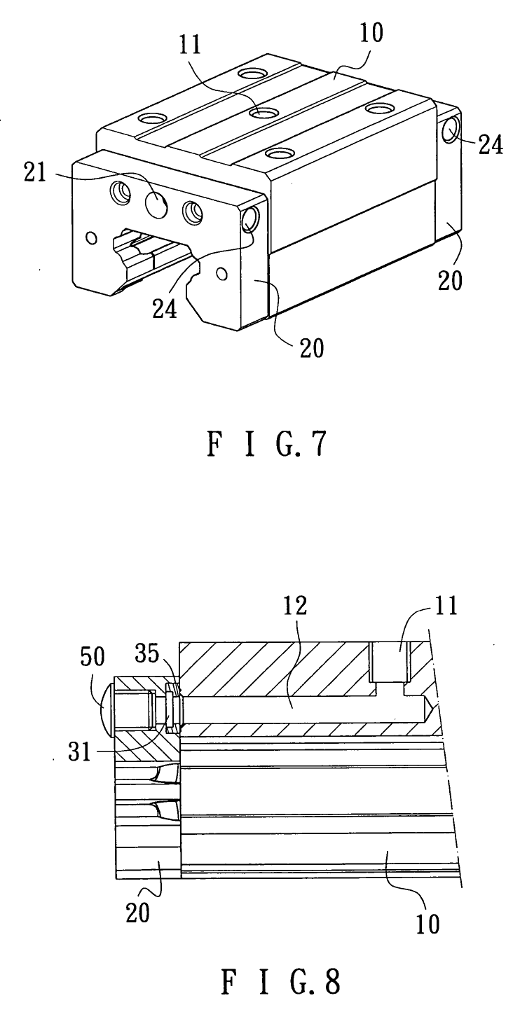

FIG. 5 is an assembly view of the end cap and the capping plate in accordance with the present invention. FIG. 6 is a cross sectional view of the assembly of the end cap and the capping plate in FIG. 5. When the oil is poured in the end cap 20 and introduced by the capping plate 30, the oil will flow into the hole 34 beside the threaded hole 26 via the oil-flowing hole 33. And a feed hole 25a is formed when the capping plate 30 is assembled with the curved surface 25 of the end cap 20, and then the oil flow into the feed hole 25a via the hole 34, since the feed hole 25a is very small, the oil is able to ooze into the upper and the lower rolling ball return way by capillary action.

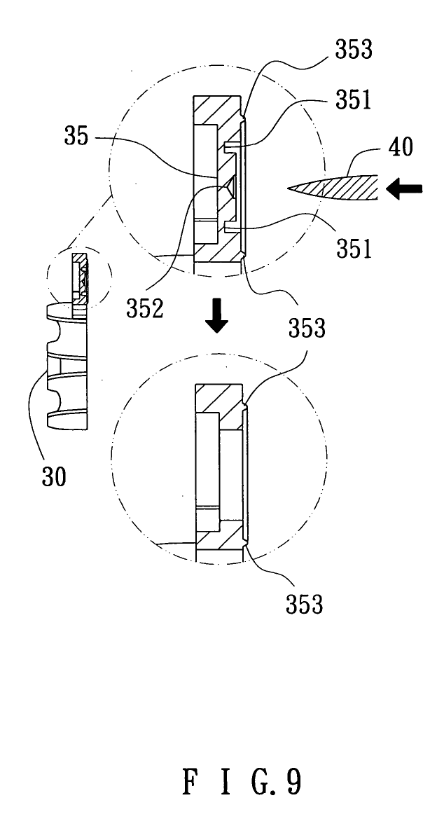

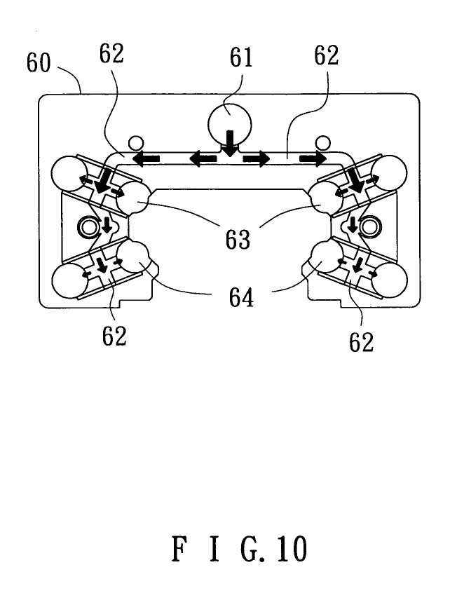

FIG. 7 is a perspective view of a lubrication system with oiling holes formed at different sides thereof in accordance with the present invention; FIG. 8 is a partial cross sectional view of FIG. 7. The present invention also can pour oil via oiling hole 11 on the top surface of the sliding block 10 besides pouring into the oiling holes 21, 24. The oil flows through the stopping piece 35 via an access 12 after it is poured into the oiling hole 11, and then to be introduced into the oil-flowing hole 31 and the oiling hole 21 respectively. At this moment, a screw 50 is screwed in the oiling hole 21 so as to close the oiling hole 21. The oil will flow along the guide route 32 to the feed hole 25a via the above-mentioned route, so as to lubricate the rolling balls in the upper and the lower rolling ball return ways.

FIG. 9 is an illustrative view of the stopping piece of the capping plate of the lubrication system in accordance with the present invention, wherein the stopping piece 35 of the capping plate 30 is installed in the oil-flowing hole 31 (on the contacting surface contacting the sliding block). The stopping piece 35 includes: annular groove 351, cone-shape recess 352 and annular protrusions 353. Since the thickness of the stopping piece 35 in the annular groove 351 is reduced and the hardness of the portion in the annular groove 351 is weak, it is easy for the user to separate the portion surrounded by the annular groove 351 from the capping plate 30 just by pushing the cone-shape recess 352 with a cone-shape tool 40, so as to produce an access on the stopping piece 35. Furthermore, an annular flange 353 is defined about the oiling hole 11 so as to improve tightness.

The lubrication system of linear guideway in accordance with the present invention has changed the oil route structure from conventional two-dimensional (2D) structure into 3D structure, so as to enable the oil to flow in a 3D manner to the middle portion between the upper and the lower rolling ball return ways, and then the oil is distributed to the respective rolling ball return ways to lubricate the rolling balls.

The lubrication system of linear guideway of the present invention has the lubricating part defined on the contacting surfaces of the end cap and of the capping plate, so as to prevent the oil leaking from the contacting surfaces of the end cap and the sliding block.

The capping plate of the present invention is additionally provided with a stopping piece used to improve tightness, and the stopping piece is designed as having detachable structure so as to improve its applicability.

While we have shown and described various embodiments in accordance with the present invention, it should be clear to those skilled in the art that further embodiments may be made without departing from the scope of the present invention.

1. A lubrication system of linear guideway comprising:
an end cap;
a capping plate;
wherein the end cap being installed at both end surfaces of a sliding block and the capping plate being installed between the sliding block and the end cap to form a 3D spatial route for enabling oil to flow to a middle portion between upper and lower rolling ball return ways, and then oil being averagely distributed to respective rolling ball return ways to lubricate rolling balls, lubricating part defined on contacting surfaces of the end cap and of the capping plate to prevent oil leakage.

2. The lubrication system of linear guideway as claimed in claim 1, wherein oil can be injected into an oiling hole defined at end surface of the end cap.

3. The lubrication system of linear guideway as claimed in claim 1, wherein oil can be injected into an oiling hole defined at side surface of the end cap.

4. The lubrication system of linear guideway as claimed in claim 1, wherein oil can be injected into an oiling hole defined on top surface of the sliding block.

5. The lubrication system of linear guideway as claimed in claim 1, wherein the capping plate is provided with stopping piece, so as to prevent oil leakage from the contacting surfaces of the end cap and the sliding block.

6. The lubrication system of linear guideway as claimed in claim 5, wherein the stopping piece is a detachable structure.
